(19) United States
(12) Patent Application Publication
(10) Pub. No.: US 2024/0318622 A1
(43) Pub. Date: Sep. 26, 2024

(54) POWER GENERATOR DRIVING DEVICE UTILIZING TIDES TO FORM LIQUID PISTON

(71) Applicant: Li-Hua Lin, Tainan City (TW)

(72) Inventors: Li-Hua Lin, Tainan City (TW); Yu-Yen Chen, Taipei City (TW); Fu-Chih Chen, Taipei City (TW)

(21) Appl. No.: 18/469,873

(22) Filed: Sep. 19, 2023

(30) Foreign Application Priority Data
Mar. 22, 2023 (TW) 112110697

(51) Int. Cl. F03B 13/26; F03G 3/00

(52) U.S. Cl. CPC F03B 13/266; F03G 3/00; F05B 2210/18; F05B 2220/7066; F05B 2270/502

(57) ABSTRACT

A power generator driving device utilizing tides to form a liquid piston comprises a fixed upside-down lid container, the container mouth is immersed in the seawater and the top end is higher than the highest sea surface while in the flood tide; and, at least one air pipe, having a first end pipe port communicating with the interior of the upside-down lid container and the other second end pipe port being defined above the sea surface, a rotating shaft of the power generator is configured outside the second end pipe port and the second end pipe port faces the windward side or the leeward side of the blade of the rotating shaft. The said configuration enables the seawater inside the upside-down lid container to form a liquid piston, and the liquid piston will gradually rise or fall accompanying with the flood tide or ebb tide of the seawater. Based on the communicating vessel principle, the air inside the upside-down lid container is squeezed by the seawater, such as the liquid piston to be blown out or suck in from the second end pipe port of the air pipe while in flood tide or ebb tide, thereby driving the blade to rotate to enable the power generator to generate electricity.

### BACKGROUND OF THE INVENTION

The present invention relates to a power generator driving device, and more particularly to a power generator driving device using tides to form a liquid piston.

### DESCRIPTION OF THE RELATED ART

Accordingly, the tidal power generation is a form of hydraulic power generation, thereby utilizing the movement of tidal stream or the rise and fall of tide sea surface to obtain energy. Although not yet widely used, the tidal power generation has a desirable potential for the future electricity generation. The tidal power generation primarily has two forms as follows: one is tidal current power, namely utilizing the power of the seawater flow to drive the turbo generator, the manner is similar with utilizing wind to drive the windmill and is a commonly used currently due to the low cost and less influence on the ecological environment, and the other form is tidal barrage, utilizing the potential energy of the high and low tides to drive the turbo generator, but the system costs high due to the requirement of corresponding civil engineering to build a barrage and causes environmental impact, and thus the system is rare in the world.

In view of utilizing the potential energy of high and low tides, the environmental impact and high cost are caused by building a barrage for the purpose of driving the power generator directly through water, the inventor has made a great effort of improving design and finally the present invention is generated.

### SUMMARY OF THE INVENTION

It is a primary objective of the present invention to provide a power generator driving device utilizing tides to form liquid piston.

The primary feature of the present invention is to comprise an upside-down lid container, wherein the open container mouth of the upside-down lid container is immersed in the seawater, the seawater is freely flowing in and out from the container and the upside down lid container is immovably fixed and the top end thereof is higher than the highest sea level in flood tide, and at least an air pipe, wherein the air pipe is provided with two end pipe ports, the first end pipe port is communicated with the interior of the upside down lid container and the second end pipe port is defined outside the upside down lid container and located above the sea surface, a rotating shaft of the power generator is installed outside the second end pipe port and the second end pipe port is facing directly the windward side or the anti-absorbing leeward side of the blades of the rotating shaft. The said configuration enables the seawater inside the upside-down lid container to become a liquid piston, whether in liquid piston will slowly rise or fall accompany with the flood tide and ebb tide of seawater, by utilizing the communicating vessels principle, while in flood tide, the seawater inside the upside-down lid container will rise accompanying with seawater to enable the air inside the upside-down lid container to be pushed by the seawater of the liquid piston and blow out from the second end pipe port of the air pipe to drive the rotation of the blades, thereby enabling the power generator to rotate and generate power, and while in ebb tide, the seawater inside the upside-down lid container will fall accompanying with the seawater to enable the external air to be sucked from the second end pipe port of the air pipe to drive the rotation of the blades, thereby enabling power generator to rotate and generate power.

The above-mentioned air pipes comprise A type and B type, wherein the first end pipe port of A-type air pipe is communicated with the interior of the upside-down lid container from a notch on the top end of the upside-down lid container, and the B-type air pipe is the top end of the upside-down lid container and closed without a notch, the first end pipe port is stretching into the air chamber on the top part inside the upside-down lid container from outside the upside-down lid container through the opening of the upside-down lid container and then is fixed, thereby enabling the air chamber to communicate with the outside air through the air pipe. The second end pipe ports of both A-type and B-type air pipes are defined outside the upside-down lid container and not allowed to be immersed in the seawater, should be higher than the highest sea level in flood tide.

The above-mentioned air pipe can be provided with a single and a power generator to form a set, or two air pipes and one power generator to form a set, and the latter is to install the power generator between the corresponding two air pipes, which can be configured as multiple sets. A coordinate of which taking the axle core of the rotating shaft to be original point, the second end pipe ports of the two air pipes are respectively installed at the diagonal quadrant position of the coordinate, thereby the second end pipe ports of the two air pipes cooperatively and simultaneously driving the rotating shaft to rotate to drive the power generator to generate electricity.

The above-mentioned rotating shaft is pushed to rotate in a reverse direction while in flood tide and ebb tide and causes the electric currents generated by the power generator in two periods having different directions, which can be overcome by a bridge-type rectifier installed at the output end of the power generator.

If the above-mentioned rotating shaft of the power generator is required to be pushed to rotate in the same direction while in flood tide and ebb tide, a one-way valve can be respectively installed on the two end pipe ports of two air pipes, and the one-way valve allows the air to pass in a reverse direction, thereby enabling the direction of the air pipes blowing or sucking the blades of the power generator to remain consistent. The above-mentioned two air pipes and one power generator can be combined to be a set and can be configured to be multiple sets.

The above-mentioned first end pipe port can be funnel-shaped and the end of the inner diameter of the wide mouth of the funnel-shaped first end pipe port is facing the top end 100 of the upside-down lid container 10 to be installed.

Other features and advantages of the present invention will become apparent from the following description of the invention which refers to the accompanying embodiments and drawings.

### BRIEF DESCRIPTION OF THE DRAWINGS

FIG. 1 is a state view of the structure and the air blowing in flood tide of the first embodiment.

FIG. 2 is a state view of the air sucking in ebb tide of the first embodiment.

FIG. 3 is a state view of the structure and the air blowing in flood tide of the second embodiment.

FIG. 4 is a state view of the air sucking in ebb tide of the second embodiment.

FIG. 5 is a state view of the structure and the air blowing in flood tide of the third embodiment.

FIG. 6 is a state view of the air sucking in ebb tide of the third embodiment.

FIG. 7 is a state view of the structure and the air blowing in flood tide of the fourth embodiment.

FIG. 8 is a state view of the air sucking in ebb tide of the fourth embodiment.

FIG. 9 is a state view of the structure and the air blowing in flood tide of the fifth embodiment.

FIG. 10 is a state view of the air sucking in ebb tide of the fifth embodiment.

FIG. 11 is a state view of the structure and the air blowing in flood tide of the sixth embodiment.

FIG. 12 is a state view of the air sucking in ebb tide of the sixth embodiment.

FIG. 13 is a state view of the structure and the air blowing in flood tide of the seventh embodiment.

FIG. 14 is a state view of the air sucking in ebb tide of the seventh embodiment.

FIG. 15 is a state view of the structure and the air blowing in flood tide of the eighth embodiment.

FIG. 16 is a state view of the air sucking in ebb tide of the eighth embodiment.

FIG. 17 is a structure view of the first end pipe port of the air pipe configured as the funnel shape according to the second embodiment.

FIG. 18 is a structure of the first end pipe por of the air pipe configured as the funnel shape according to the fifth embodiment.

### DETAILED DESCRIPTION OF EMBODIMENTS OF THE INVENTION

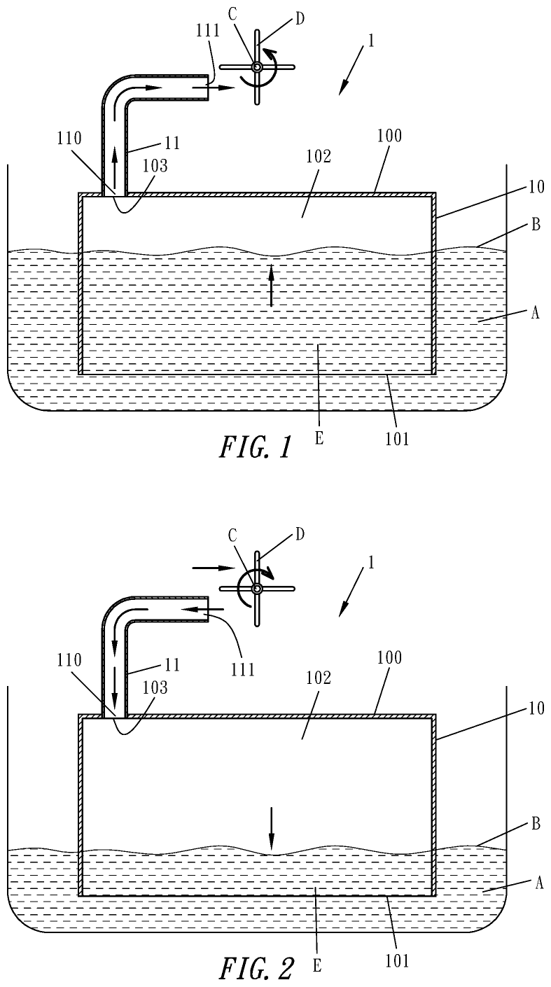

With reference to FIGS. 1 and 2, the power generator driving device 1 of the first embodiment comprises:
an upside-down lid container 10 has an open container mouth 101 immersed in the seawater A, the top end 100 is higher than the highest sea surface B when the seawater is in flood tide, the position of the upside-down lid container 10 is fixed immovably to maintain the open container mouth to be permanently immersed in the seawater A and the top end 100 of the upside-down lid container 10 rises to the sea surface, thereby forming an air chamber 102 between the interior of the upside-down lid container 10 and the sea surface B. The seawater of FIG. 1 is only shown in schematic diagram; and
at least an air pipe 11 has two end pipe ports, the first end pipe port 110 is communicating with the interior of the upside-down lid container 10 via a notch 103 on the top end 100 of the upside-down lid container 10, the other second end pipe port 111 is located outside the upside-down lid container 10 and permanently higher the sea surface B, thereby enabling the air inside the air chamber 102 to communicate with the air outside the upside-down lid container 10, and the rotating shaft C of a power generator is installed outside the second end pipe port 111 and the second end pipe port 111 faces directly the windward side of blade D radially installed from the periphery of the rotating shaft C.

Based on such a configuration, the seawater A inside the upside-down lid container 10 is similar as a liquid piston E, wherein the liquid piston E will slowly rise or fall accompanying with flood tide or ebb tide of the seawater, and in view of utilizing the communicating vessel principle, the seawater A upside-down poured into the upside-down lid container 10 inside the seawater A will gradually rise accompanying with the rise of the sea surface B to enable the air inside the air chamber 102 to be squeezed by the seawater A of the liquid piston E to blow out from the second end pipe port 111 of the air pipe 11, thereby driving the rotation of the blade D to drive the power generator to generate electricity, and while in ebb tide, the seawater inside the upside-down lid container 10 will slowly fall accompanying with the fall of the seawater outside the upside-down lid container 10, the liquid piston E moves downward and the external air is sucked in via the second end pipe port 111 of the air pipe 11 to enable the blade D to be driven to rotate in a reverse direction to enable the power generator to rotate and generate electricity.

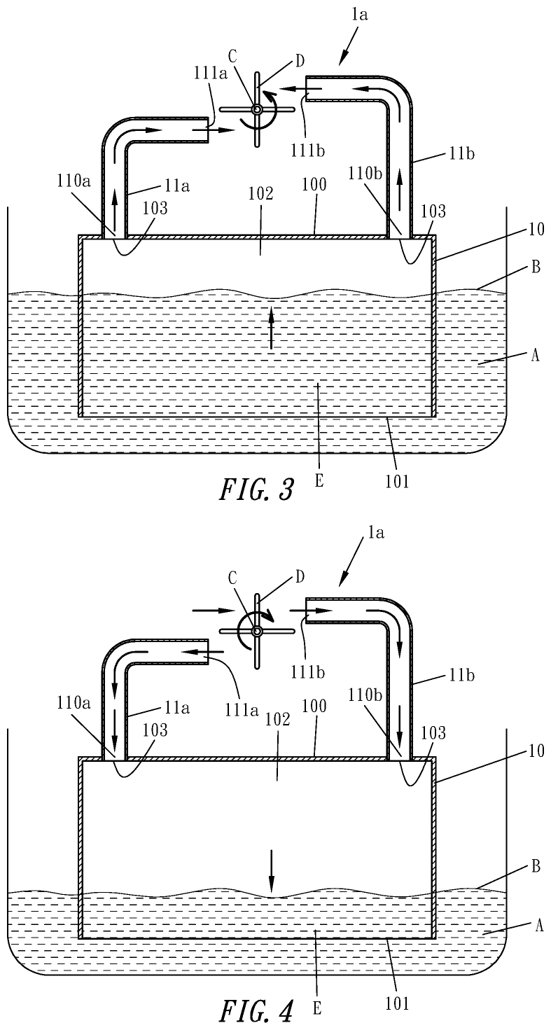

FIGS. 3 and 4 are direct to a power generator driving device 1a of the second embodiment having a structure almost same as the power generation driving device 1 of the first embodiment and the main difference between the two embodiments is that two air pipes are combined into a set (multiple sets are allowed to run together). The second end pipe ports 111a, 111b of the two air pipes 11a, 11b are installed at the diagonal quadrant position of the coordinate taking the axle center of the rotating shaft C as an origin point (as shown in FIG. 3, the second end pipe port 111b is installed at the first quadrant position, the second end pipe port 111a is installed at the third quadrant position, and similarly, they can be installed at the second and fourth quadrant positions as well) and are respectively aligned to the blade D, thereby the two air pipes 11a, 11b being capable of cooperatively and simultaneously driving the rotating shaft C to rotate to enable the power generator to generate electricity. When the seawater is in flood tide, as shown in FIG. 3, the liquid piston E squeezes the air inside the air chamber 102 to be into the pipe via the first end pipe port 110a, 110b of the air pipe 11a, 11b and further blown out from the second end pipe port 111a, 111b to blow the blade D to rotate and enable the power generator to generate electricity. When the seawater is in ebb tide, as shown in FIG. 4, the liquid piston E moves downward slowly accompanying with the seawater A to enable the external air to be sucked in via the second end pipe ports 111a, 111b of the air pipes 11a, 11b, and the leeward side of the blade D is suck and driven to rotate in a reverse direction, thereby enabling the power generator to generate electricity.

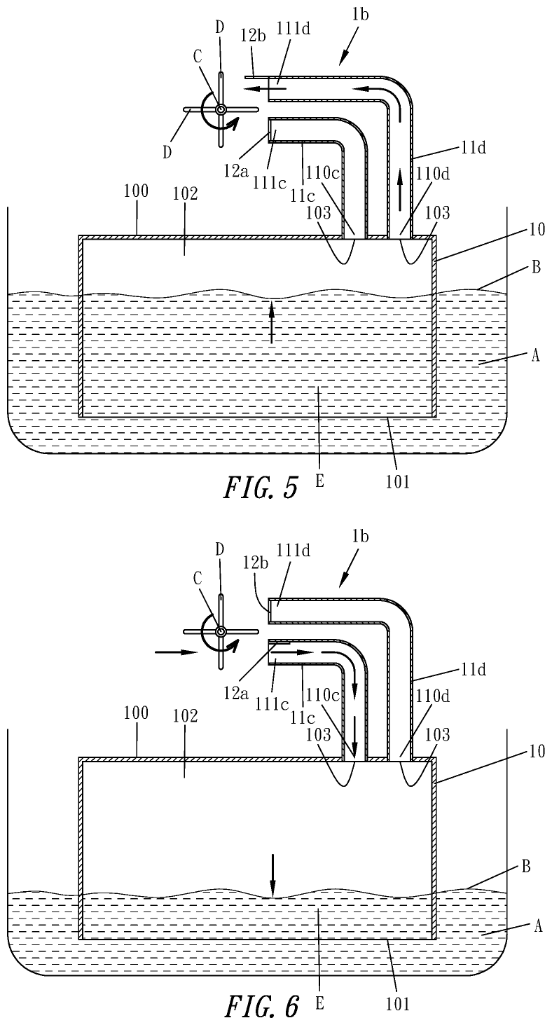

FIGS. 5 and 6 are direct to the power generator driving device 1b of the third embodiment. In order to enable the rotating shaft C of the power generator to driven by the blowing or suction while the seawater A being in flood tide or ebb tide to rotate in the same direction, the second end pipe ports 111c, 111d of the two air pipes 11c, 11d are installed at the position taking the axle center of the rotating shaft C as a coordinate origin, namely, the second end pipe ports 111c, 111d of the two air pipes 11c, 11d are installed at the adjacent quadrant position of the coordinate (for example, the first and fourth quadrants or the second and third quadrants or the first and second quadrants or the third and fourth quadrants), and a one-way valve 12a, 12b is respectively installed inside the second end pipe ports 111c, 111 d of the two air pipes 11c, 11d, wherein the two one-way valves 12a, 12b allow the air to pass in a reverse direction and the first end pipe ports 110c, 110d are communicating with the air chamber 102 via the notch 103, thereby enabling the two air pipes 11c, 11d to blow air to or suck air from the blade D of the power generator while the seawater A being in flood tide or ebb tide and thus, the rotating shaft C becoming to rotate in the same direction while the seawater A being in flood tide or ebb tide and the direction of generated currents being consistent.

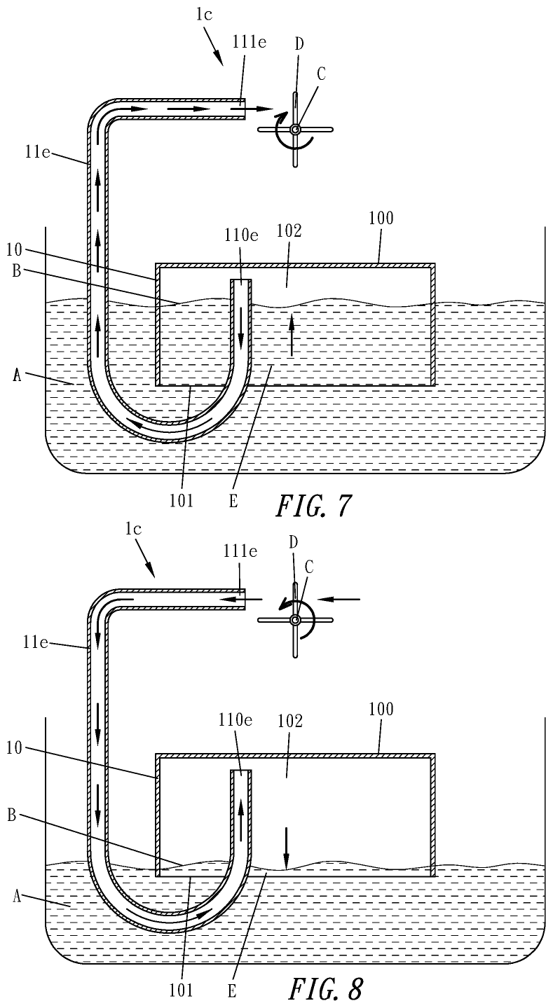

The above-mentioned air pipes 11, 11a, 11b, 11c, 11d of the first, second and third embodiments are defined as A-type air pipe, and the first end pipe ports 110, 110a, 110b, 110d of the A-type air pipe are communicating with the interior of the upside-down lid container 10 via the notch 103 on the top end 100 of the upside-down lid container 10. The following B-type air pipe as shown in FIGS. 7 and 8, is related to the top end 100 of the upside-down lid container 10 being closed without a notch, the first end pipe port 110e of the air pipe 11e is stretching into the top end of the air chamber 102 from the outside of upside-down lid container 110 to pass through the container mouth 101 and the first end pipe port 110e is higher than the highest sea surface inside the upside-down lid container 10, thereby fixing it to enable the air chamber 102 to be communicated with external air and formed through the first end pipe port 110e and the second end pipe port 111e of the air pipe 11e. The second end pipe ports of both A-type air pipe and B-type air pipe are outside the upside-down lid container, not allowed to be immersed in the seawater and necessary to be higher than the highest sea surface while in flood tide.

The above-mentioned FIGS. 7 and 8 are direct to the power generator driving device 1c of the fourth embodiment having the structure almost same as the power generator driving device 1 of the first embodiment (as shown in FIGS. 1 and 2), and the main difference is that the A-type air pipe of the first embodiment is changed to the B-type air pipe, and the rest are the same.

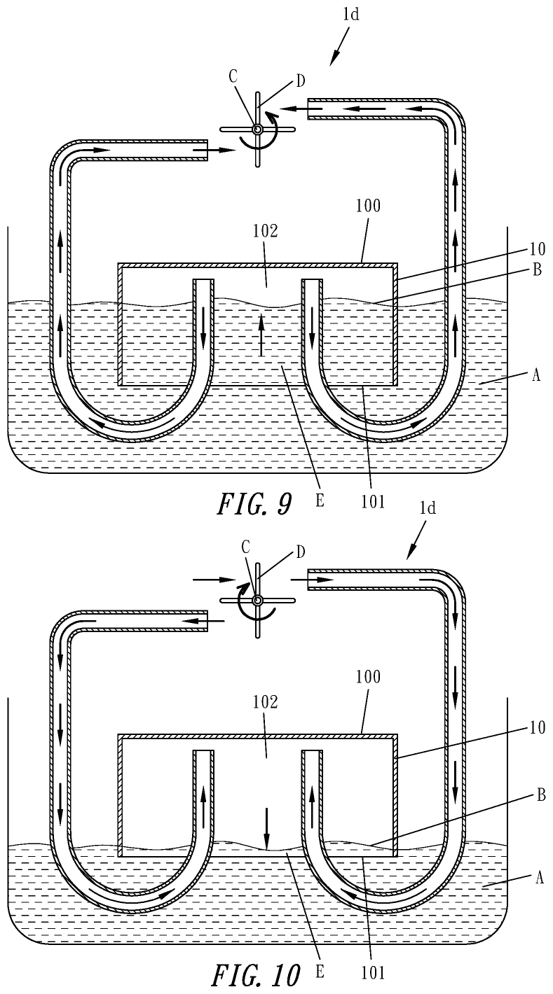

FIGS. 9 and 10 are direct to the power generator driving device 1d of the fifth embodiment having the structure almost same as the power generator driving device 1a of the second embodiment (as shown in FIGS. 3 and 4) and the main difference is that the A-type air pipe of the second embodiment is changed to the B-type air pipe, and the rest are the same.

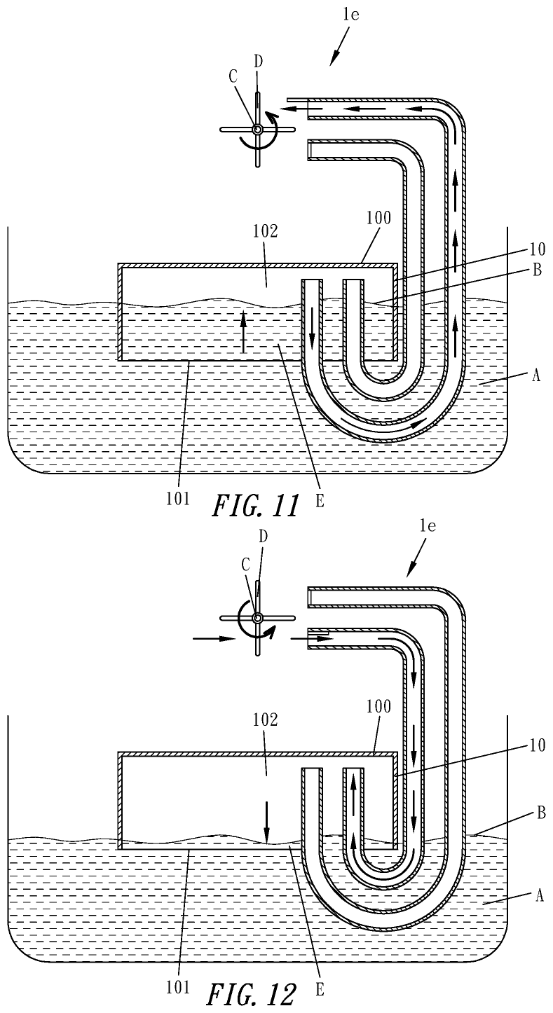

FIGS. 11 and 12 are direct to the power generator driving device 1e of the sixth embodiment having the structure almost same as the power generator driving device 1b of the third embodiment (as shown in FIGS. 5 and 6) and the main difference is that the A-type air pipe of the third embodiment is changed to the B-type air pipe, and the rest are the same.

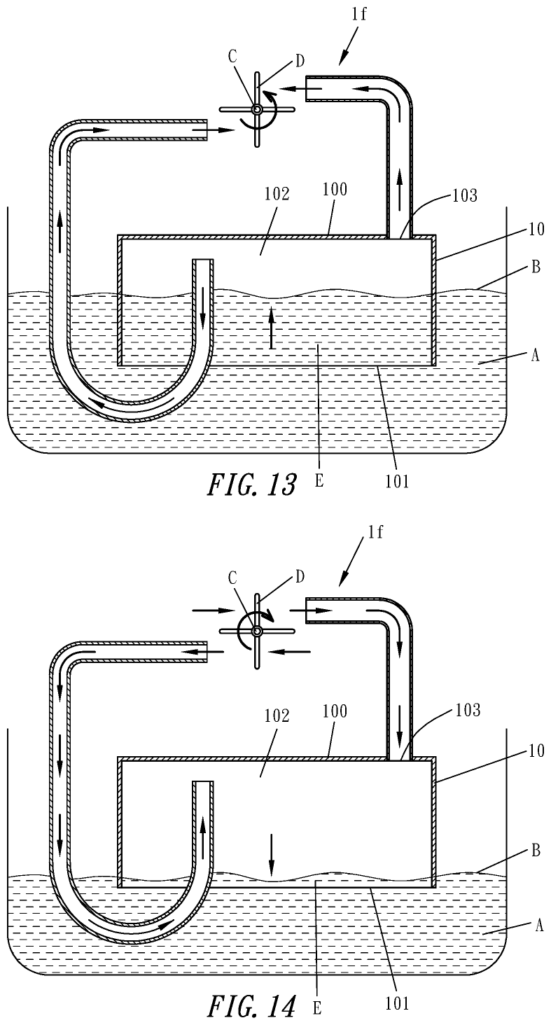

FIGS. 13 and 14 are direct to the power generator driving device if of the seventh embodiment having the structure almost same as the power generator driving device 1a of the second embodiment (as shown in FIGS. 3 and 4) and the main difference is that the two A-type air pipes of the second embodiment are changed to one A-type air pipe and one B-type air pipe, and the rest are the same.

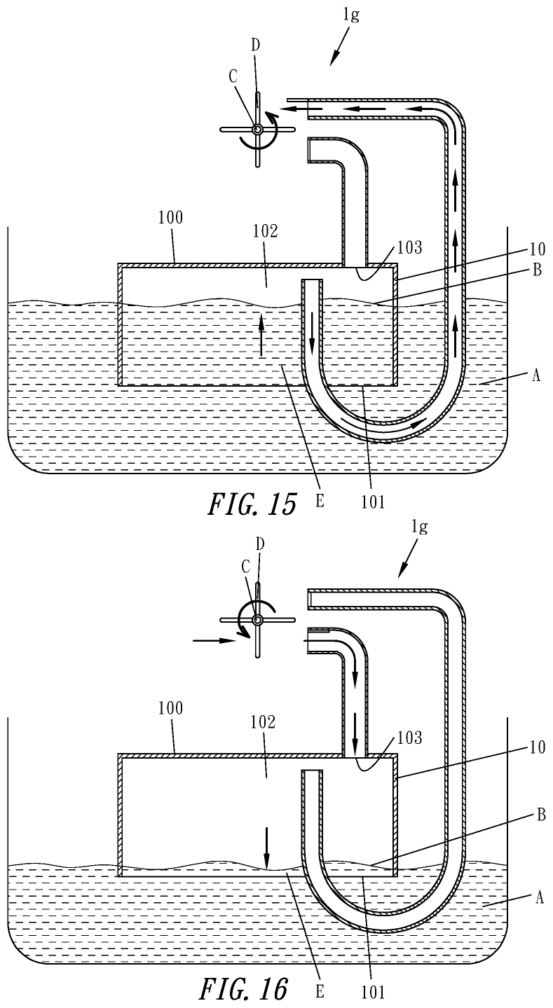

FIGS. 15 and 16 are direct to the power generator driving device 1g of the eighth embodiment having the structure almost same as the power generator driving device 1b of the third embodiment (as shown in FIGS. 5 and 6) and the main difference is that the two A-type air pipes of the third embodiment are changed to one A-type air pipe and one B-type air pipe, and the rest are the same.

The rotating shaft C of the power generator in the first, second, fourth, fifth, and seventh embodiments will be driven by the air blowing or sucking to rotate in forward or reverse directions when the seawater A are in flood tide or ebb tide, enabling the generation currents of two phases of the power generator to be different. However, the electric currents in reverse direction can be solved via an external rectifier (for example, a bridge-type rectifier) to enable the flow direction to be consistent after the electric currents being derived. In the third, sixth, and eighth embodiments, the electric currents are in the same direction while in flood tide and ebb tide.

The installing positions of the second end pipe ports of two air pipes are facing each other, the installing positions of the second end pipe ports can take the axle center of the rotating shaft to be as an origin point of the coordinate and the second end pipe ports of two air pipes are installed at the diagonal quadrant position of the coordinate (for example, to install at the diagonal quadrant position of the first and third quadrants or at the second and fourth quadrant positions). If the second end pipe ports of the two air pipes face toward the same direction, the installing positions thereof are the adjacent quadrant position of the first and fourth quadrants or the second and third quadrants.

The configuration of the power generator can be a set of two air pipes pushing the rotating shaft of one power generator (or one air pipe pushing the rotating shaft of one power generator to be one set) and one upside-down lid container can be configured with multiple sets, or the second end pipe ports of multiple air pipes jointly push one power generator to generate electricity.

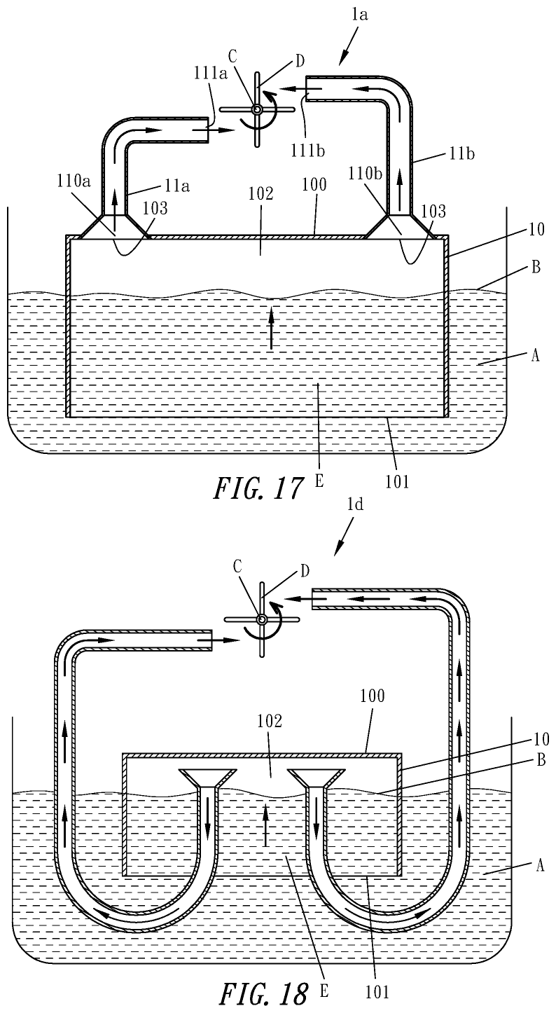

Moreover, the first end pipe port 110a of the air pipe 11a as shown in FIG. 3, can be installed in a funnel shape to communicate with the interior of the upside-down lid container 10, and the end of the inner diameter of the wide mouth of the funnel faces the top end 100 of the upside-down lid container 10, as shown in FIG. 17, thereby the liquid piston E squeezing the air inside the air chamber 102 to be into more easily through the funnel-shaped first end pipe port 110a, 110b more easily. FIG. 9 is direct to the first end pipe port stretching into the upside-down lid container 10 being a funnel shape as well, as shown in FIG. 18. Similarly, the first end pipe ports in other embodiments can also be installed in a funnel shape.

It can be seen from the above, the power generator driving device of the present invention is to immerse the container mouth of the upside-down lid container in the seawater via the combination of the upside-down lid container and air pipe, thereby enabling the seawater inside the upside-down lid container to have a function same as a piston, and the seawater inside the upside-down lid container become a liquid piston and utilizes the nature phenomenon of the rise or fall of sea surface when the seawater is in flood tide or ebb tide to enable the liquid piston inside the upside-down lid container to move accompanying with the rise or fall the seal surface and further causing the air pipes to blow air to or suck air from the rotating shaft of the power generator to drive the blade to rotate and enabling the power generator to generate electricity. The power generator driving device has the simple structure and low cost and to utilize the cycle rise and fall of tides to drive the power generator to generate electricity is belonging to a Patent application related to green technology capable of saving energy.

Moreover, no matter the tidal range is large or small, the present invention is worth to develop. If the tidal range is larger, the volume of blowing air in flood tide and the volume of sucking air in ebb tide are both numerous. If the tidal range is small, the sectional surface of the upside-down lid container put upside down into the seawater can be enlarged and a volume of blowing air in flood tide rise and a volume of sucking air in ebb tide are also numerous.

In summary, the present invention meets the requirements of novelty, inventiveness and practical applicability, and therefore an application for patent is hereby filed according to the law. Your examination and approval will be highly appreciated.

What is claimed is:

1. A power generator driving device utilizing tides to form a liquid piston, comprising
an upside-down lid container, wherein an open container mouth of the upside-down lid container being immersed in the seawater and a top end being higher than the highest sea surface while in flood tide, the position of the upside-down lid container being fixed to maintain the container mouth to be permanently immersed in the seawater but the seawater being capable of freely flowing in and out from the container mouth, and an air chamber being formed between an interior of the upside-down lid container and the sea surface and the seawater flowing into the upside-down lid container to become a liquid piston;
at least an air pipe having two end pipe ports, the first end pipe port being communicating with an interior of the air chamber, the other second end pipe port being installed outside the upside-down lid container and higher than the sea surface to enable the air inside the air chamber to communicate with the air outside the upside-down lid container; and
a rotating shaft of the power generator being configured outside the second end pipe port, wherein the second end pipe port directly facing a windward side or a leeward side of a blade radially installed at the periphery of the rotating shaft, to utilize the flood and ebb tides of the seawater and the communicating vessel principle, the liquid piston slowly rising or falling accompanying with the flood tide or the ebb tide of the seawater to enable the air pipe to blow air to or suck air from the blade, thereby driving the rotating shaft to rotate to enable the power generation to generate electricity.

2. The power generator driving device utilizing tides to form a liquid piston of claim 1, wherein the first end pipe port communicates with the interior of the upside-down lid container via a notch installed at the top end of the upside-down lid container, the second end pipe port is located outside the upside-down lid container and higher than the highest sea surface while in flood tide, and said air pipe is defined as an A-type air pipe.

3. The power generator driving device utilizing tides to form a liquid piston of claim 1, wherein the first end pipe port is stretching into the air chamber on the top end of the upside-down lid container from the outside of the upside-down lid container via the container mouth and higher than the highest sea surface of the interior of the upside-down lid container and is fixed, to enable the air chamber to communicate with the outside air through the air pipe, and the second end pipe port is located at the outside of the upside-down lid container and higher than the highest sea surface of the flood tide, and said air pipe is defined ed as a B-type air pipe.

4. The power generator driving device utilizing tides to form a liquid piston of claim 1, wherein the air pipe is provided with two and the second end pipe ports of the two air pipes face toward to a same direction and respectively locate at an adjacent quadrant position of a coordinate taking a center of the rotating shaft as an origin.

5. The power generator driving device utilizing tides to form a liquid piston of claim 1, wherein the air pipe is provided with two, the second end nozzles of the two air pipes face toward a same direction and respectively locate at an adjacent quadrant position of a coordinate taking the center of the rotating shaft as origin, and an one-way valve is configured respectively inside the second end nozzles of the two air pipes and the two one-way valves allow the air to pass in a reverse directions.

6. The power generator driving device utilizing tides to form a liquid piston of claim 4, wherein a bridge-type rectifier is externally attached with the currents derived when the power generator generates electricity.

7. The power generator driving device utilizing tides to form a liquid piston of claim 5, wherein the two air pipes combine with one power generator to form a set and the multiple air pipes combined with one power generator to form a set is acceptable, and one upside-down lid container are capable of be installed with the multiple combined sets of the air pipes and the power generators.

8. The power generator driving device utilizing tides to form a liquid piston of claim 1, wherein the first end pipe port is a funnel shape and the end of the inner diameter of the wide mouth of the funnel faces the top end of the upside-down lid container to be installed.
